(19) United States
(12) Patent Application Publication
(10) Pub. No.: US 2015/0019282 A1
(43) Pub. Date: Jan. 15, 2015

(54) Supply Chain Systems and Methods of Use

(71) Applicant: Pan-Pro, L.L.C., Tinley Park, IL (US)

(72) Inventor: Thomas A. Kozak, Tinley Park, IL (US)

(21) Appl. No.: 13/940,388

(22) Filed: Jul. 12, 2013

(51) Int. Cl. G06Q 10/06

(52) U.S. Cl. CPC G06Q 10/06315
USPC 705/7.25

(57) ABSTRACT

The present invention generally relates to the field of supply chain management, and more specifically, to methods and systems for improving product flow between parties such as manufacturers, distributors, and end users. In one embodiment, the present invention identifies, captures, and integrates future project business needs into the manufacturer's procurement/production processes. This may allow the manufacturer to meet supply chain needs regardless of the demand history or sales velocity of a product.

### FIELD OF INVENTION

The present invention generally relates to the field of supply chain management, and more specifically, to methods and systems for improving product flow between parties such as manufacturers, distributors, and end users.

### BACKGROUND

A modern-day product supply chain often includes manufacturers, distributors, and end users. Manufacturers are typically the source of various products which ultimately end up in the hands of end users (such as contractors) who install or otherwise use these products at their respective sites. However, in many instances manufacturers prefer to sell to distributors rather than directly to end users. Such an arrangement can provide certain benefits to all three parties. For example, the end users may only have to go to one or few distributors to obtain a large selection of products, manufacturers can sell their products in larger quantities to fewer parties, and distributors can enable the aforementioned conveniences while benefiting from the process.

For a manufacturer, the determination of which and how many products to procure is generally driven by forecasts of future demand (which can be referred to as “flow business”), actual orders requesting future delivery of products (which can be referred to as “project business”), or a combination of both. Inventory for flow business is typically built, and placed into inventory, before the manufacturer has received an actual demand such as a purchase order for a product. Inventory for project business is typically built in response to the manufacturer receiving a demand for a specific product.

Over time, some improvements in the traditional supply chain system have been recognized. A traditional supply chain is characterized by a manufacturer responding to demands (i.e., purchase orders) placed by their distributors, end users/contractors, other product consumers, or a combination thereof. To improve the efficiency of this relationship, some manufacturers have implemented automated replenishment systems that generate purchase orders on behalf of their supply chain partners, eliminating or reducing the need for those partners to perform traditional purchasing activities. An example of an automated replenishment system is disclosed in U.S. Pat. No. 5,608,621 to Caveney et al., entitled “SYSTEM AND METHOD FOR CONTROLLING THE NUMBER OF UNITS OF PARTS IN AN INVENTORY,” issued on Mar. 4, 1997, and incorporated herein by reference in its entirety. The use of such a system in a supply chain is illustrated in FIG. 1, where the automated replenishment system 20 receives inventory and demand information from the distributor 25, product-related information from the manufacturer 30, and generates optimized purchase orders 35, which are then executed by the manufacturers during their Pick/Pack/Ship/Bill operations 40.

However, with the current state of the art, neither traditional fulfillment nor advanced automated replenishment systems and methods address project business successfully for the entire supply chain, particularly for items with long procurement or long manufacturing lead times. In many cases the demand signal from the supply chain reaches the manufacturer so close to the time that the product is needed for installation that the manufacturer has difficulty in procuring or producing, and delivering the product as needed. Thus, there exists a need for improved systems and methods which improve the efficiency of a supply chain relationship.

### SUMMARY

Accordingly, embodiments of the present invention are generally directed to various systems and methods designed to improve the efficiency of the relationship between members of a supply chain.

In one embodiment, the present invention identifies, captures, and integrates future project business needs into the manufacturer's procurement/production processes. This may allow the manufacturer to meet supply chain needs regardless of the demand history or sales velocity of a product.

In another embodiment, the present invention is a system which links an end user (i.e., a contractor), a distributor, and a manufacturer.

In yet another embodiment, the present invention is a supply chain system for use at least between a distributor and at least one manufacturer, the supply chain system comprising at least one computing device with a processor and a non-transitory computer readable medium storing an automated replenishment system (ARS) component and a project-specific component (PSC), the PSC being in communication with the ARS component. The PSC obtains project business data associated with a specific end-user project from at least one of the distributor and an end- user, and the PSC obtains flow business data from the distributor. The PSC also generates a manufacture-triggering order to the at least one manufacturer, the manufacture-triggering order triggering the at least one manufacturer to begin at least one of manufacturing and procurement of a project product required for the at least one specific end-user project. And the ARS component generates a purchase order on behalf of the distributor for execution by the at least one manufacturer, the purchase order comprising at least one of an order for flow product estimated to be required by the distributor at some future time and an order for the project product required for the at least one specific end-user project.

In still yet another embodiment, the present invention is a supply chain system for use at least between a distributor and a manufacturer, the supply chain system comprising a supply chain optimization component executed on at least one computing device with a processor and a non-transitory computer readable medium storing the supply chain optimization component. The supply chain optimization component obtains project business data associated with a specific end-user project from at least one of the distributor and an end-user, and the supply chain optimization component obtains flow business data not associated with the specific end-user project from the distributor. The supply chain optimization component communicates a manufacture-triggering order to the manufacturer, the manufacture-triggering order triggering the manufacturer to begin at least one of manufacturing and procurement of at least one of a project product required for the at least one specific end-user project and a flow product estimated to be required by the distributor at some future time. And the supply chain optimization component communicates a purchase order on behalf of the distributor to the manufacturer, the purchase order comprising at least one of an order for flow product and an order for project product.

In still yet another embodiment, the present invention is a method for managing a supply chain system between at least a distributor and a manufacturer. The method comprises the steps of: employing at least one computing device with a processor and a non-transitory computer readable medium storing a supply chain optimization component; having the supply chain optimization component obtain project business data associated with a specific end-user project from at least one of the distributor and an end-user; having the supply chain optimization component obtain flow business data from the distributor; having the supply chain optimization component communicate a manufacture-triggering order to the manufacturer, the manufacture-triggering order triggering the manufacturer to begin at least one of manufacturing and procurement of at least one of a project product required for the at least one specific end-user project and a flow product estimated to be required by the distributor at some future time; having the supply chain optimization component further communicate a purchase order on behalf of the distributor to the manufacturer, the purchase order comprising at least one of an order for flow product and an order for project product; and having the manufacturer execute the purchase order.

These and other features, aspects, and advantages of the present invention will become better-understood with reference to the following drawings, description, and any claims that may follow.

### BRIEF DESCRIPTION OF THE DRAWINGS

FIG. 1 illustrates an implementation of a known example of an automated replenishment system between a manufacturer and a distributor.

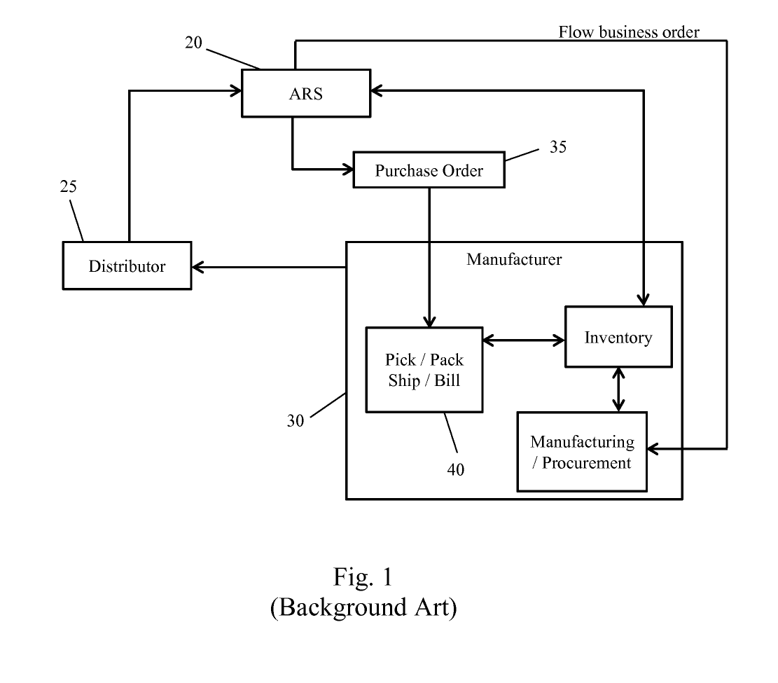

FIG. 2 illustrates an implementation of an embodiment of the present invention in a supply chain involving a manufacturer, distributor, and an end user.

FIG. 3 illustrates an implementation of another embodiment of the present invention in a supply chain involving a manufacturer, distributor, and an end user.

### DETAILED DESCRIPTION

The present invention makes use of the discovery that a typical supply loop (also referred herein to as a “supply chain”) may be expanded to include project-specific information which relates to specific end users.

In the description that follows, at least some of the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

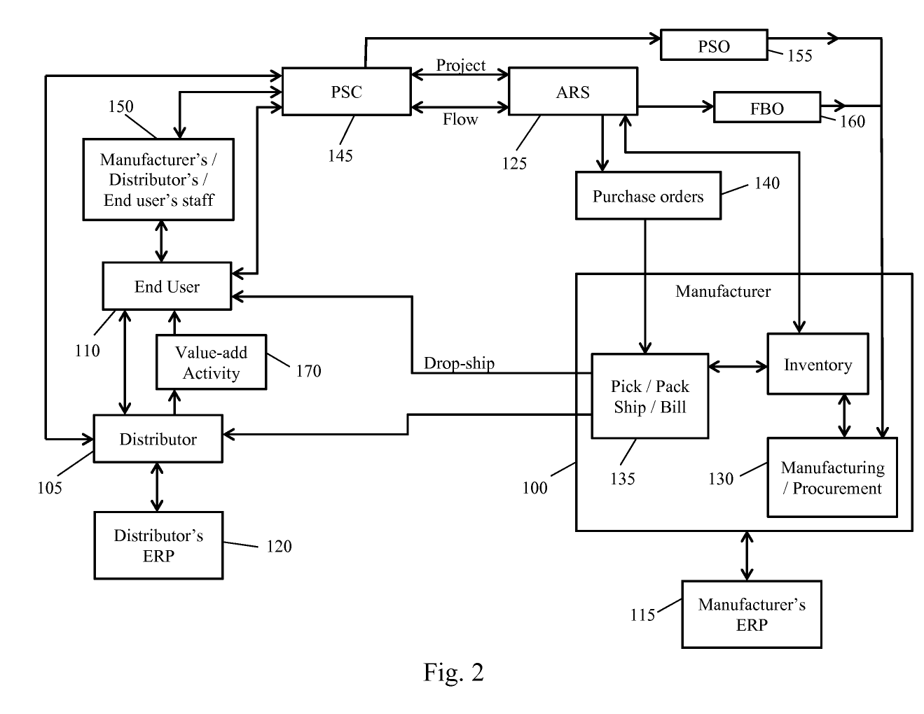

Referring now to FIG. 2 in more detail, this figure illustrates a supply chain 10 in accordance with an embodiment of the present invention where three primary parties are involved: (1) manufacturer 100; (2) distributor 105; and (3) an end-user 110 (e.g., contractor). To help integrate internal and external management of information across an entire organization, both the manufacturer and distributor use commercially available or in-house developed enterprise resource planning (ERP) software systems. These manufacturer and distributor ERP systems 115,120 can be used to manage and operate as many business functions as possible within the generalized methods and functionality of the ERP systems. Additional software systems may be used to provide additional or expanded functionality and methods beyond the base ERP capabilities. One example of such additional software is the automated replenishment system 125.

As a basic premise, the primary role of the manufacturer 100 in the case of the supply chain 10 is to manufacture or procure one or more particular goods and to place those goods into the stream of commerce. The manufacturer 100 typically does this by producing the goods in its plant 130 and later shipping those goods to a distributor 105 during its Pick/Pack/Ship/Bill (PPSB) operations 135 which generally involve picking the appropriate goods from the manufacturer's inventory, packing/staging then accordingly, shipping the packaged/staged products to their respective destinations, and billing the appropriate party. The manufacturer 100 executes the PPSB operations 135 against purchase orders 140, which, in the currently described embodiment, take into account both flow and project business.

As noted previously, flow business is generally based on the historical trends of product flow between the manufacturer 100 and distributor 105. However, the currently described embodiment of the present invention incorporates a project-specific component (PSC) 145 into the overall product/information loop 10 between the manufacturer 100 and the distributor 105.

The project-specific component can enable systems and methods of the present invention to identify, capture, and integrate future project business needs into the manufacturer's 100 production/procurement processes. This may allow the manufacturer to meet supply chain needs regardless of the demand history or sales velocity of a product. Furthermore, integration of a project-specific component with an automated replenishment system (ARS) may allow the manufacturer and distributor to retain the commonly associated benefits and efficiencies of such an ARS.

The project-specific information (project plan) required for the PSC 145 is based at least in part on the project-specific needs of an end-user 110. In an embodiment, the project plan includes information related to goods and respective quantities required for any projected period. In an embodiment, any combination of the manufacturer's, end-user's, and distributor's staff 150 participate and/or collaborate to the degree desired by the supply chain to compile project-specific information (e.g., products, quantities, receive-by dates, etc.) for the PSC 145. In some embodiments, the project plan is executed via the distributor 105, by having the distributor 105 act as the point of contact between the end-user 110 and the manufacturer 100. In a preferred embodiment, the project plan is created in advance of a respective project's start date. However, in alternate embodiments, the PSC 145 can be implemented at any portion of the project's duration and the project plan may be created and/or modified at any time before or during a respective project.

While the project plan data relates to project-specific information, products included in this list do not necessarily have to fall under project business for either the distributor or the manufacturer. An example of this condition is where a distributor provides a product from a manufacturer to many end customers and for many projects on a regular basis. Although the product is a project part to the end customer in the sense that it is used in some project, the products demand pattern is such that the product demand can be fulfilled from normal flow business inventory maintained at the distributor and/or manufacturer.

The PSC 145 can automatically interact with the ARS 125 and determine which product may be provided from the flow business inventory at the distributor and/or manufacturer, and which product requires special handling and processing to meet the planned project needs. These planned project needs can include mutually agreed to pre-stage timeframes, where the distributor agrees to pre-stage the product in advance of the project's planned use period, allowing the end customer to move up their planned consumption within the pre-stage period when beneficial to the completion of the project. The ability to identify and segregate products that are treated as project business by the supply chain may allow the project needs to be met without unnecessary and/or costly inventory investments, transactional costs, and manual interventions.

When the PSC 145 determines that a project plan has been created and that certain product(s) are project products, it generates a project staging order (PSO) 155 for project business items necessary to fulfill the specific project plan. The PSO 155 is then submitted to the manufacturer 100 ahead of the project plan's due date so that the manufacturer can incorporate pre-stage, transit, pick/pack/ship, manufacture, and/or raw materials lead times as appropriate for particular product(s) and as necessary to meet the project plan. The PSOs 155 are used by the manufacturer 100 (typically by way of interacting with the manufacturer's ERP system 115) to trigger the production of the project-specific product. The PSOs 155 can also be used by the manufacturer 100 to link the product and quantity (or other features/qualities) to the specific end customer/project requirement. This link can help ensure that other demand(s) on the manufacturer do not consume the product manufactured for a particular end customer/project.

Note that in addition to receiving PSOs 155, the manufacturer 100 may receive flow business orders (FBO) 160. FBO's are generated by the ARS 125 as part of ARS's normal forecasting of future need of non-project-specific items. Similar to PSOs, FBOs 160 trigger the production of flow-business products. PSOs 155 FBOs 160 may be referred to as manufacture- triggering orders. The segregation of PSOs 155 and FBOs 160 may further help the manufacturer 100 ensure that flow business demands do not interfere with successful fulfillment of PSOs prior to the respective project plan's due date.

In addition to receiving PSOs 155 and FBOs 160 which trigger the manufacturing/procurement process, manufacturer 100 receives ARS-generated purchase orders 140 which trigger the manufacturer's PPSB 135 procedures. In the currently described embodiment, the PSC 145 transactionally notifies the ARS 125 of when to include project-specific product data (e.g., product type, planned quantity, target fulfillment date, etc.) on purchase orders 140. Additionally, the PSC 145 notifies the ARS 125 of when to include the planned product information (e.g., minimum product quantity) in the ARS's flow business planning process. This can help ensure that sufficient quantities of flow business products are available to cover any temporary demand variations which can be attributed to individual projects.

The separation of PSOs/FBOs 155,160 from purchase orders 140 allows the manufacturer to obtain the information necessary to begin the manufacturing/procurement process of flow and/or business products without having to keep track of particular PPSB dates. Instead, the necessary lead times are calculated and forecasted by the PSC 145 and/or the ARS 125, potentially simplifying and streamlining the manufacturer's operations.

The PSC 145 can also help identify products that cannot be supplied as specified in the plan to indicate that the supply chain must undertake appropriate fulfillment activities or the product will not be available per plan. For example, this may occur if the manufacturer 100 does not have the appropriate resources to manufacture/procure the necessary products in time, or if the shipping constrains prevent the necessary goods from being delivered as needed. Resulting fulfillment activities are likely to be rare and are likely to occur in extenuating circumstances.

The PSC 145 can optionally provide access and visibility to necessary alerts regarding the project plan to the contractors 110, distributors 105, and manufacturers 100. Such alerts can include, but are not limited to, product manufacture and shipment status. Additionally, the PSC 145 can provide role based security to limit each user's access and visibility to projects, products, distributors, manufacturers, and etc. based on various criteria.

The inclusion of the PSC 145 can also help with the accuracy of the ARS system 125. In particular, the aggregation of project-specific demands from multiple supply chain partners can result in a scenario where certain products are treated as project business products by the distributors while those same products are treated as flow business products by the manufacturer. Such a discrepancy may lead to incorrect forecasting by the ARS 125, potentially causing unnecessary inventory buildup when the project-specific demand subsides. The PSC 145 can help segregate project and flow business such that flow business is forecasted more accurately.

Once the manufacturer fulfills an ARS order the manufactured products can be kept either at the manufacturer's site until an appropriate time or shipped to the distributor by way of the PPSB 135 operations. Alternatively, a product may be drop-shipped to the end user 110 directly from the manufacturer. This may save on shipping costs, reduce shipping time, and allow products to bypass unnecessary checkpoints. Such a drop-ship arrangement may be particularly useful in the event that the products are large and cannot be easily stored at the distributor or if the products are not otherwise conducive to shipping through one or more intermediary.

In some cases, prior to ultimate distribution to the end users 110, distributors 105 may perform value-add activities 170 on products received from the manufacturer. For example, the distributor 105 may “kit” products from multiple manufacturers such that the end user 110 has all products necessary to complete a discrete project. These activities may be of particular value to end users 110 who are working on a specific construction project at a specific job site.

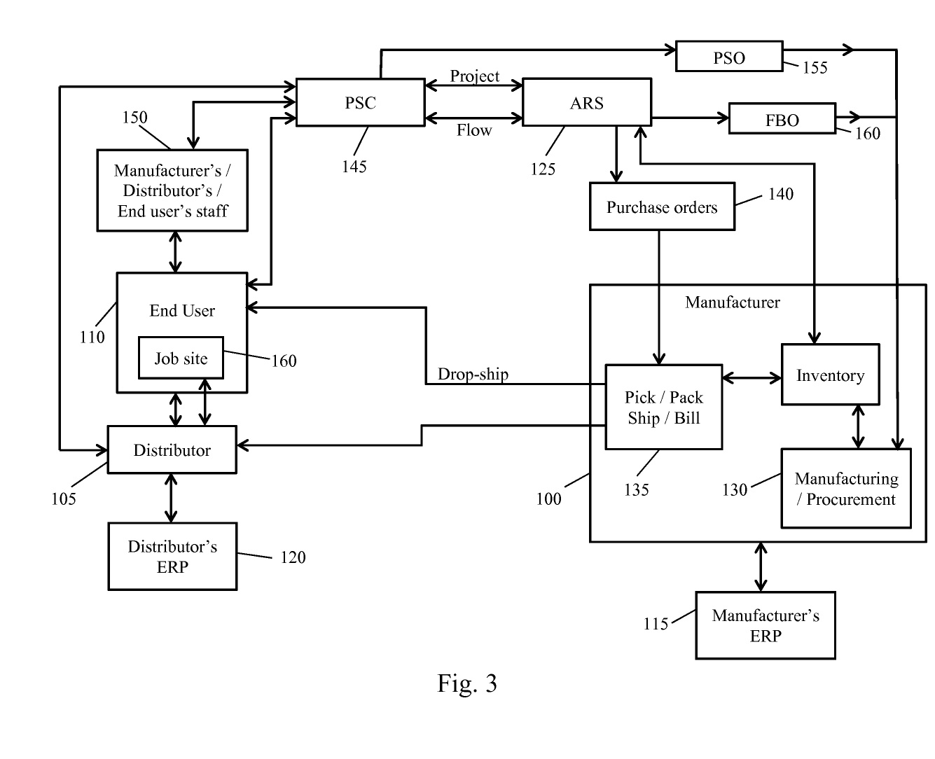

FIG. 3 shows an alternate embodiment of a supply chain according to the present invention. Distributor's 105 operations may use features of the distributor's ERP system 120 to retain and manage the inventory status of products staged for or placed at a job site 160. Typically, the distributor 105 will create an inventory location for the job site and manually update the ERP records via transactions to provide a computer record of product consumption (often identified via on-site visits and counts (manual or semi-automated), on hand products, and product transfers to or from the site 160.

In the present embodiment, a distributor 105 that maintains distributor ERP site inventory records in their ERP system 120 can send data regarding that inventory to the ARS 125. The ARS can utilize this data in coordination with the PSC plan and ARS optimized replenishment plan to notify the distributor 105 via alerts, or notify the distributor's ERP system 120 via transactions to pre-notify the distributor to move specific products and quantities from the distributor 105 to the job site 160. This may provide further elimination of manual work, costs, and errors which can delay or stall an end customer's project completion, result in lost sales, etc.

While the above-described embodiments have referenced only one manufacturer, in alternate embodiments the present invention may be implemented in an environment where multiple manufacturers are present. As such, in generating PSOs, FBOs, and purchase orders, the PSC and the ARS can determine the appropriate manufacturer to which the orders must be routed. Thus, when a project plan calls for products from multiple manufacturers, the present invention may be used to help obtain the needed parts from the multiple manufacturers by the required due dates.

Note that while the embodiments shown in various figures differ, similar/like elements are referenced using same/like numbers. Also note that the PSC and the ARS may be implemented on single or on multiple components, and may comprise individual modules of a single piece of software or may comprise separate pieces of software linked to one another via suitable communication means.

The supply chain of the above-described embodiments may be implemented using at least one computer. At least some of the operations described above may be codified in computer readable instructions such that these operations may be executed by the computer. The computer may be a stationary device (e.g., a server) or a portable device (e.g., a laptop). The computer includes a processor, memory, and one or more drives or storage devices. The storage devices and their associated computer storage media provide storage of computer readable instructions, data structures, program modules and other non-transitory information for the computer. Storage devices include any device capable of storing non-transitory data, information, or instructions, such as: a memory chip storage including RAM, ROM, EEPROM, EPROM or any other type of flash memory device; a magnetic storage devices including a hard or floppy disk, and magnetic tape; optical storage devices such as a CD-ROM disc, a BD-ROM disc, and a B1uRay™ disc; and holographic storage devices.

The computer may operate in a networked environment using logical connections to one or more remote computers, such as a remote computer. The remote computer may be a personal computer, a server, a router, a network PC, a peer device or other common network node, and may include many if not all of the elements described above relative to computer. Networking environments are commonplace in offices, enterprise-wide computer networks, intranets and the Internet. For example, in the subject matter of the present application, a computer may comprise the source machine from which data is being migrated, and the remote computer may comprise the destination machine. Note, however, that source and destination machines need not be connected by a network or any other means, but instead, data may be migrated via any media capable of being written by the source platform and read by the destination platform or platforms. When used in a LAN or WLAN networking environment, a computer is connected to the LAN through a network interface or an adapter. When used in a WAN networking environment, a computer typically includes a modem or other means for establishing communications over the WAN to environments such as the Internet. It will be appreciated that other means of establishing a communications link between the computers may be used.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. Accordingly, the invention is not to be restricted except in light of the appended claims and their equivalents.

I claim:

1. A supply chain system for use at least between a distributor and at least one manufacturer, the supply chain system comprising:
at least one computing device with a processor and a non-transitory computer readable medium storing an automated replenishment system (ARS) component and a project-specific component (PSC), the PSC being in communication with the ARS component,
wherein the PSC obtains project business data associated with a specific end-user project from at least one of the distributor and an end-user,
wherein the PSC obtains flow business data from the distributor,
wherein the PSC generates a manufacture-triggering order to the at least one manufacturer, the manufacture-triggering order triggering the at least one manufacturer to begin at least one of manufacturing and procurement of a project product required for the at least one specific end-user project, and
wherein the ARS component generates a purchase order on behalf of the distributor for execution by the at least one manufacturer, the purchase order comprising at least one of an order for flow product estimated to be required by the distributor at some future time and an order for the project product required for the at least one specific end-user project.

2. The supply chain system of claim 1, wherein the at least one computing device comprises a plurality of computing devices, and wherein the plurality of computing devices distribute the PSC and the ARS component such that at least a part of the PSC is on one of the plurality of computing devices and at least a part of the ARS component is on another one of the plurality of computing devices.

3. The supply chain system of claim 1, wherein the project business data includes a due date, the due date signifying a date at which the project product will be required for the at least one specific end-user project.

4. The supply chain system of claim 3, wherein the purchase order comprising the order for the project product is generated prior to the due date and wherein the purchase order comprising the order for the project product is executed by the at least one manufacturer prior to the due date.

5. The supply chain system of claim 3, wherein the due date is based in part on at least one of the at least one manufacturer's ability to manufacture the project product before the due date and the distributor's ability to deliver the project product before the due date.

6. The supply chain system of claim 1, wherein upon execution of the purchase order comprising the order for the project product, the at least one manufacturer delivers the project product to at least one of the distributor and the end-user.

7. The supply chain system of claim 1, wherein the end-user maintains a job site inventory, and wherein a predetermined change in the job site inventory triggers the PSC obtaining the project business data.

8. A supply chain system for use at least between a distributor and a manufacturer, the supply chain system comprising:
a supply chain optimization component executed on at least one computing device with a processor and a non-transitory computer readable medium storing the supply chain optimization component,
wherein the supply chain optimization component obtains project business data associated with a specific end-user project from at least one of the distributor and an end-user,
wherein the supply chain optimization component obtains flow business data not associated with the specific end-user project from the distributor,
wherein the supply chain optimization component communicates a manufacture-triggering order to the manufacturer, the manufacture-triggering order triggering the manufacturer to begin at least one of manufacturing and procurement of at least one of a project product required for the at least one specific end-user project and a flow product estimated to be required by the distributor at some future time, and
wherein the supply chain optimization component communicates a purchase order on behalf of the distributor to the manufacturer, the purchase order comprising at least one of an order for flow product and an order for project product.

9. The supply chain system of claim 8, wherein the supply chain optimization component comprises an automated replenishment system (ARS) component and a project-specific component (PSC), the PSC being in communication with the ARS component.

10. The supply chain system of claim 9, wherein the manufacture-triggering order for the project product is generated by the PSC, wherein the manufacture-triggering order for the flow product is generated by the ARS component, and wherein the purchase order is generated by the ARS component.

11. The supply chain system of claim 8, wherein the project business data includes a due date, the due date signifying a date at which the project product will be required for the at least one specific end-user project.

12. The supply chain system of claim 11, wherein the purchase order comprising the order for the project product is generated by the supply chain optimization component and is executed by the manufacturer prior to the due date.

13. The supply chain system of claim 11, wherein the due date is based in part on at least one of the manufacturer's ability to manufacture the project product before the due date and the distributor's ability to deliver the project product before the due date.

14. The supply chain system of claim 8, wherein the purchase order is executed by the manufacturer, and wherein upon execution of the purchase order comprising the order for the project product the manufacturer delivers the project product to at least one of the distributor and the end-user.

15. The supply chain system of claim 8, wherein the end-user maintains a job site inventory, and wherein a predetermined change in the job site inventory triggers the supply chain optimization component obtaining the project business data.

16. A method for managing a supply chain system between at least a distributor and a manufacturer, the method comprising the steps of:
employing at least one computing device with a processor and a non-transitory computer readable medium storing a supply chain optimization component;
having the supply chain optimization component obtain project business data associated with a specific end-user project from at least one of the distributor and an end-user;
having the supply chain optimization component obtain flow business data from the distributor;
having the supply chain optimization component communicate a manufacture-triggering order to the manufacturer, the manufacture-triggering order triggering the manufacturer to begin at least one of manufacturing and procurement of at least one of a project product required for the at least one specific end-user project and a flow product estimated to be required by the distributor at some future time;
having the supply chain optimization component further communicate a purchase order on behalf of the distributor to the manufacturer, the purchase order comprising at least one of an order for flow product and an order for project product; and
having the manufacturer execute the purchase order.

17. The method of claim 16, wherein the supply chain optimization component comprises an automated replenishment system (ARS) component and a project-specific component (PSC), the PSC being in communication with the ARS component.

18. The method of claim 17, wherein the manufacture-triggering order for the project product is generated by the PSC, wherein the manufacture-triggering order for the flow product is generated by the ARS component, and wherein the purchase order is generated by the ARS component.

19. The method of claim 16, wherein the project business data includes a due date, the due date signifying a date at which the project product will be required for the at least one specific end-user project.

20. The method of claim 19, wherein the purchase order comprising the order for the project product is generated by the supply chain optimization component and is executed by the manufacturer prior to the due date.
